(19) United States
(12) Patent Application Publication
(10) Pub. No.: US 2026/0083268 A1
(43) Pub. Date: Mar. 26, 2026

(54) INTELLIGENT COOKING MACHINE

(71) Applicant: SHANG HAI AICAN ROBOT (GROUP) CO., LTD., Shanghai (CN)

(72) Inventors: Qing HE, Shanghai (CN); Guang HE, Shanghai (CN); Gang YANG, Shanghai (CN)

(21) Appl. No.: 19/408,697

(22) Filed: Dec. 4, 2025

Related U.S. Application Data
(63) Continuation of application No. PCT/CN2024/091625, filed on May 8, 2024.

(30) Foreign Application Priority Data
Jun. 13, 2023 (CN) 202310698076.5

(51) Int. Cl. A47J 27/00; A47J 36/06; A47J 36/16; A47J 36/32; A47J 36/38; F24C 15/20; H05B 6/64; H05B 6/70; H05B 6/76

(52) U.S. Cl. CPC A47J 27/004; A47J 36/06; A47J 36/165; A47J 36/32; A47J 36/38; F24C 15/2007; H05B 6/6417; H05B 6/6432; H05B 6/707; H05B 6/763; H05B 2206/044

(57) ABSTRACT

An intelligent cooking machine is disclosed including a sealed cavity housing a cooking pot assembly which consists of a cooking pot, a stove core for heating the cooking pot, and a lid capable of covering the pot opening of the cooking pot. When the cooking pot containing ingredients rotates and is hermetically covered by the lid above it, at least one set of microwave generators installed on the lid feeds microwaves into the ingredients within the pot. Based on the original heating method, the invention incorporates a microwave heating component installed on the lid, which does not require daily removal. The microwaves generated by the microwave heating component are directly or through at least one waveguide tube fed into the ingredients that are being stirred and rotating with the pot.

### CROSS-REFERENCE TO RELATED APPLICATIONS

This application is a continuation of International Patent Application No. PCT/CN2024/091625 with a filing date of May 8, 2024, designating the United States, now pending, and further claims priority to Chinese Patent Application No. 202310698076.5 with a filing date of Jun. 13, 2023. The content of the aforementioned applications, including any intervening amendments thereto, are incorporated herein by reference.

### TECHNICAL FIELD

The disclosure relates to an intelligent cooking machine, and more particularly, to an intelligent cooking machine that uses microwave heating as an auxiliary heat source.

### BACKGROUND ART

Existing intelligent cooking machines consist of a machine frame, a sealed cavity, a cooking pot assembly a material feeding device, etc. While dishes cooked by such intelligent cooking machines according to set programs can rival stir-fried dishes prepared by chefs, they still have the following shortcomings:

1. Due to the single heating method employed by existing intelligent cooking machines, their heating efficiency is low, resulting in a relatively long time required to cook one dish.

2. When cooking lightweight and bulky vegetarian ingredients, relying solely on conductive heat can easily lead to undercooked dishes.

3. When cooking meat ingredients, under high heating power, a short cooking time can easily result in the ingredients being cooked on the outside but raw on the inside, while a long cooking time can easily lead to the ingredients being cooked internally but charred and burnt on the outside.

### SUMMARY

The technical problem solved by the present invention is to provide an intelligent cooking machine that can effectively improve cooking efficiency, enhance cooking quality, and shorten the time difference between the internal and external doneness of cooked ingredients.

To solve the aforementioned technical problem, the disclosure provides an intelligent cooking machine, which includes a sealed cavity housing a cooking pot assembly. The cooking pot assembly includes a cooking pot, a stove core for heating the cooking pot, and a lid capable of covering the pot opening of the cooking pot. When the cooking pot containing ingredients rotates and is hermetically covered by the lid above it, at least one set of microwave generators installed on the lid feed microwaves into the ingredients within the pan.

Preferably, each of the microwave generators feeds microwaves into the pan through at least one waveguide tube, and a waveguide cover is provided at the outlet of the waveguide tube.

Preferably, an exhaust pipe is provided on the lid to discharge oil fumes generated in the cooking pot to a fume treatment device, and an isolation structure is provided within the exhaust pipe to prevent microwaves from leaking outward with the airflow.

Preferably, a flipping fork is further provided within the cooking pot, capable of turning the ingredients over and rotating relative to the cooking pot.

Preferably, a sealing structure is provided between the lid and the pot opening to prevent microwave leakage.

Preferably, the control circuit further includes a control module that disconnects the operating power supply of the magnetron in the microwave generator(s) when a lid-opening signal is sent to the lid or the cooking pot.

Preferably, a touch switch is provided between the lid and the pot opening, which cuts off the control circuit of the microwave generator(s) when the lid moves away from the pot opening.

Preferably, a microwave leakage detection device is provided near the outside of the lid and within the exhaust pipe. These microwave leakage detection device is electrically connected to a microwave radiation alarm device in the control circuit.

In the prior art, cooking machines have a relatively single heating method, typically using conductive heating or electromagnetic coil heating. A single heating method can easily lead to long cooking times and low cooking quality. The present invention adds a microwave heating component based on the main heating method being electromagnetic heating, and installs the microwave heating component on the lid which does not need to be disassembled daily. The microwaves generated by the microwave heating component are fed directly or through at least one waveguide tube into the ingredients which are in a state of being stirred and rotating with the cooking pot. The advantages of this structure are that it enables balanced internal and external heating of the cooked ingredients, significantly shortens the cooking duration, and results in cooked dishes that are fragrant on the outside and tender on the inside.

### DESCRIPTION OF THE ACCOMPANYING DRAWINGS

FIG. 1 is a schematic structural diagram of the intelligent cooking machine of the disclosure;

FIG. 2 is a cross-sectional view of the cooking pot and lid of the intelligent cooking machine of the disclosure;

FIG. 3 is a cross-sectional view of the lid of the intelligent cooking machine of the disclosure;

In the drawings: Sealed cavity 100, Machine casing 10, Door panel 11, Inner shell 20, Stove core 30, cooking pot 40, Lid 50, Upper fixing disc 51, Lower fixing disc 52, Lid body 53, Sealing structure 54, Material feeding device 60, cooking pot lifting device 70, cooking pot station control device 80, Fume treatment device 90, Exhaust pipe 91, Microwave generator 1, Waveguide tube 2, Waveguide cover 3.

### BEST MODE FOR CARRYING OUT THE INVENTION

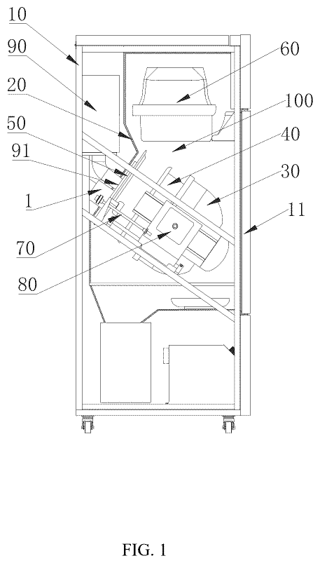

As shown in FIG. 1, the intelligent cooking machine of the disclosure includes a machine casing 10, a sealed cavity 100 within the machine casing 10 (this sealed cavity 100 is formed by an inner shell 20 arranged inside the machine casing 10 with a front opening, and the door panel 11 of the cooking machine), a cooking pot assembly, a cooking pot lifting device 70, a material feeding device 60, a cooking pot station control device 80, a fume treatment device 90, and a main control device.

The cooking pot assembly includes a cooking pot 40, a stove core 30 for heating the cooking pot 40, and a lid 50 capable of covering the pot opening of the cooking pot 40. The stove core 30 consists of an inner cover, a heating component, and an outer cover. Preferably, the inner cover has an upper opening, the bottom of the inner cover is flat, and the vertical cross-sectional shape of the inner cover is arc-shaped, this arc shape being the same as the arc shape of the vertical cross-section of the lower half of the cooking pot 40. The heating component comprises an electromagnetic coil and several fixing members. The electromagnetic coil surrounds the outer wall of the inner cover and is fixed to the inner cover through the fixing members. The outer cover is a cylindrical structure with an upper opening. The cooking pot 40 is housed within the inner cover and can rotate about its central axis relative to the stove core 30.

The lid 50 is arranged inside the sealed cavity 100 and positioned at the rear upper part of the sealed cavity 100. The stove core 30, through the cooking pot lifting device 70, allows the cooking pot 40 to move directionally with its pot opening facing the lid 50 and to sealably engage with the lid 50, and is mounted within the sealed cavity 100 in this manner. The material feeding device 60 is used for dispensing ingredients into the cooking pot 40 and is arranged inside the sealed cavity 100 above the cooking pot 40. The cooking pot station control device 80 is used to fix the stove core 30 onto the cooking pot lifting device 70 and controls the stove core 30 to tilt so that the pot opening of the cooking pot 40 faces corresponding stations (such as the pot opening facing the lid position, the pot opening facing the material feeding device 60 position, and the pot opening facing the dish output position, etc.) to perform corresponding operations.

The fume treatment device 90 is arranged in the inter layer formed between the machine casing 10 and the inner shell 20. An exhaust port is provided on the lid 50. This exhaust port is connected through an exhaust pipe to the fume treatment device 90 to discharge oil fumes generated in the cooking pot 40 to the fume treatment device 90 for treatment before being discharged out of the sealed cavity 100 or circulated back into the sealed cavity 100 for further treatment.

Based on the heating provided by the stove core 30, the disclosure incorporates microwave heating as an auxiliary heat source to provide thermal energy to the cooking pot 40, compensating for losses or insufficient heat supply during high-power heating by the electromagnetic coil. Taking the rapid heating method of microwaves as an auxiliary heat supply greatly improves cooking efficiency and simultaneously solves the problem of inconsistent internal and external doneness of ingredients during cooking with traditional single heating methods. A detailed description is provided below in conjunction with specific embodiments.

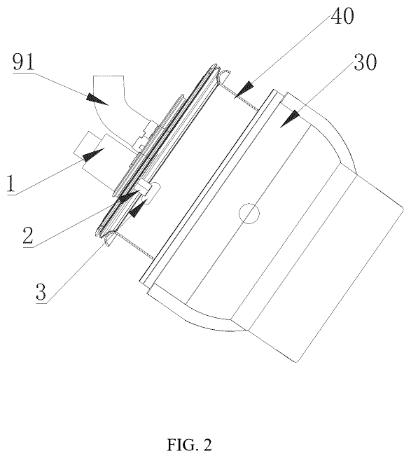

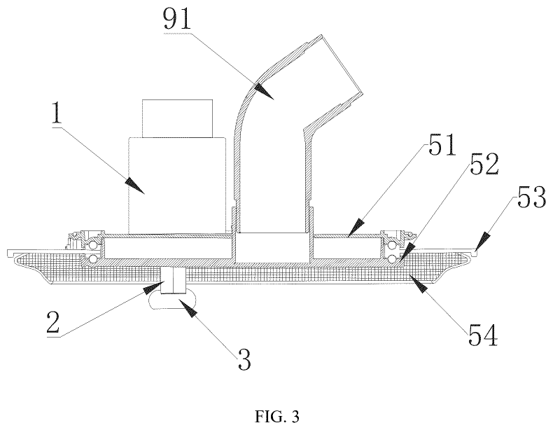

As shown in FIGS. 2-3, the material of the lid 50 is a microwave isolation material. It comprises a rotating disc assembly and a lid liner assembly. The rotating disc assembly and the lid liner assembly are arranged coaxially. The rotating disc assembly includes an upper fixing disc 51 and a lower fixing disc 52. The lid body 53 of the lid liner assembly is rotatably clamped between the upper fixing disc 51 and the lower fixing disc 52. A through hole adapted to the upper fixing disc 51 is provided on the rear side surface of the inner shell 20. The outer side surface of the upper fixing disc 51 (the side facing away from the lower fixing disc 52 is defined as outer) passes through the through hole and is fixed within the through hole via a mounting frame provided on the outer wall of the rear side of the inner shell 20, thereby fixing the entire lid 50 rotating assembly to the rear side surface of the inner shell 20.

At least one set of microwave generator(s) 1 is provided on the outer side of the upper fixing disc 51. The microwave generator(s) 1 feed microwaves into the cooking pot 40 through at least one waveguide tube 2. The microwave energy emitted by the microwave generator(s) 1 enters from one end of the waveguide tube 2 and is fed into the cooking pot 40 from the other end that passes through the upper fixing disc 51 and the lower fixing disc 52. A waveguide cover 3 is also provided at said other end of the waveguide tube 2 to prevent water vapor, oil fumes, etc., from entering the waveguide tube 2 during the cooking process and thereby contaminating the microwave source. The waveguide cover 3 can be made of a microwave-transparent material that is food-grade.

The microwave generator(s) 1 can also feed microwaves into the cooking pot 40 through other waveguide structures, such as providing waveguide channels in the upper fixing disc 51 and the lower fixing disc 52.

When the cooking pot 40 containing ingredients rotates and sealably engages with the lid liner assembly, the microwave generator(s) 1 feed microwaves into the ingredients within the cooking pot 40.

By installing the microwave generator(s) 1 on the fixed component of the lid 50 and feeding microwaves into the rotating cooking pot 40, and by having the cooking pot 40 and the lid 50 form a closed cooking cavity when engaged, microwaves reflect back and forth within the closed cooking cavity and pass through or by the ingredients, achieving rapid heating of the ingredients. Simultaneously, the main control circuit controls the rotation of the cooking pot 40 to drive the stirring of the ingredients within the cooking pot 40, so that the microwave energy is uniformly distributed on the ingredients, heating them evenly.

When the cooking pot 40 moves away from the lid 50 to perform other cooking actions (the material feeding device dispenses ingredients into the cooking pot 40 or dish output after cooking is completed), the main control circuit controls the microwave generator(s) 1 to stop working, avoiding microwave leakage. The specific control methods are disclosed as follows.

Firstly, the control circuit further includes a control module that disconnects the operating power supply of the magnetron in the microwave generator(s) 1 when a lid-opening signal is sent to the lid 50 or the cooking pot 40.

Secondly, a touch switch (not shown in the figures) is provided between the lid 50 and the pot opening, which cuts off the control circuit of the microwave generator(s) 1 when the lid 50 moves away from the pot opening.

Thus, through this dual safety control method, it is ensured that the microwave generator(s) 1 are turned off when the lid is opened, guaranteeing safety during the cooking process.

Further, to prevent microwave leakage from the engagement point between the lid 50 and the pot opening, a sealing structure 54 capable of preventing microwave leakage is provided along the circumferential direction of the lid body 53. The sealing structure 54 preferably has the following structures:

1. The sealing structure is a metal mesh. The metal mesh has an annular structure, formed by two edges connected into a “V”-shaped cross-section. The metal mesh is fixed along the circumference of the lid body 53 with its “V”-shaped opening facing the central axis of the lid body 53. When the lid body 53 covers the cooking pot 40, one edge of the metal mesh presses against the pot opening of the cooking pot 40 and can elastically deform under the pressure of the cooking pot 40 to tightly fit against the pot opening of the cooking pot 40 (the aperture of the metal mesh meets the requirements for preventing microwave leakage).

2. The sealing structure is a sealing ring coated with a microwave-reflective coating.

3. The sealing structure is a sealing ring with a wire grid inside it, the wire grid being made of metal.

When the lid body 53 covers the pot opening of the cooking pot 40, the metal mesh or sealing ring elastically presses against the pot opening. When the cooking pot 40 rotates, the cooking pot 40 drives the lid body 53 to rotate synchronously via frictional resistance, so that during the rotational cooking process of the cooking pot 40, the lid body 53 remains sealably engaged with the pot opening of the cooking pot 40 via the sealing structure 54, preventing microwaves within the cooking pot 40 from leaking from the engagement point between the lid 50 and the cooking pot 40 pot opening.

Upwardly and downwardly connected openings are provided in the upper fixing disc 51 and the lower fixing disc 52. One end of the exhaust pipe 91 is connected to the openings, and the other end is connected to the fume inlet of the fume treatment device 90.

An isolation structure is provided within the exhaust pipe 91 to prevent microwaves from leaking outward with the wind. The isolation structure is a metal wire grid (the grid aperture of the metal wire grid meets the requirements for preventing microwave leakage).

Further, a flipping fork (not shown in the figures) is provided within the cooking pot 40, capable of turning the ingredients over and rotating relative to the cooking pot 40. The flipping fork can be made of food-grade non-metallic material or smooth-surfaced metal material. During the cooking process, the flipping fork is always covered by ingredients to avoid the accumulation of a large amount of charge and the generation of electric sparks under the action of microwaves.

By providing the flipping fork in the cooking pot 40 to stir the ingredients, the present invention makes the stirring of ingredients more uniform, further improving the heating effect of microwave heating.

Microwave leakage detection devices are provided at any position near the outside of the lid 50 and within the exhaust pipe 91 located after the isolation structure. These microwave leakage detection devices are electrically connected to a microwave radiation alarm device in the control circuit.

What is claimed is:

1. An intelligent cooking machine, comprising a sealed cavity housing a cooking pot assembly; wherein the cooking pot assembly includes a cooking pot, a stove core for heating the cooking pot, and a lid capable of covering a pot opening of the cooking pot; wherein when the cooking pot containing ingredients rotates and is hermetically covered by the lid above it, at least one set of microwave generators installed on the lid feeds microwaves into the ingredients within the cooking pot.

2. The intelligent cooking machine of claim 1, wherein each of the microwave generators feeds microwaves into the cooking pot through at least one waveguide tube, and a waveguide cover is provided at an outlet of the waveguide tube.

3. The intelligent cooking machine of claim 2, wherein an exhaust pipe is provided on the lid to discharge oil fumes generated in the cooking pot to a fume treatment device, and an isolation structure is provided within the exhaust pipe to prevent microwaves from leaking outward with airflow.

4. The intelligent cooking machine of claim 3, wherein a flipping fork is provided within the cooking pot, capable of turning the ingredients over and rotating relative to the cooking pot.

5. The intelligent cooking machine of claim 4, wherein a sealing structure is provided between the lid and the pot opening to prevent microwave leakage.

6. The intelligent cooking machine of claim 5, wherein a control circuit includes a control module configured to disconnect an operating power supply of a magnetron in the microwave generator when a lid-opening signal is sent to the lid or the cooking pot.

7. The intelligent cooking machine of claim 6, wherein a touch switch is provided between the lid and the pot opening configured to cut off the control circuit of the microwave generator when the lid moves away from the pot opening.

8. The intelligent cooking machine of claim 7, wherein a microwave leakage detection device is provided near an outside of the lid and within the exhaust pipe; the microwave leakage detection device is electrically connected to a microwave radiation alarm device in the control circuit.
